(19) United States
(12) Patent Application Publication
(10) Pub. No.: US 2025/0217415 A1
(43) Pub. Date: Jul. 3, 2025

(54) RECORDING APPARATUS, CONTROL METHOD THEREOF, RECORDING MEDIUM, AND SYSTEM

(71) Applicant: CANON KABUSHIKI KAISHA, Tokyo (JP)

(72) Inventors: YUKI YAMAMOTO, Tokyo (JP); TOSHIO MINOSHIMA, Kanagawa (JP); TOMOAKI KOMIYAMA, Kanagawa (JP)

(21) Appl. No.: 19/083,785

(22) Filed: Mar. 19, 2025

Related U.S. Application Data
(63) Continuation of application No. PCT/JP2023/030287, filed on Aug. 23, 2023.

(30) Foreign Application Priority Data
Sep. 29, 2022 (JP) 2022-156463

(51) Int. Cl. G06F 16/783; H04N 23/661

(52) U.S. Cl. CPC G06F 16/783; H04N 23/661

(57) ABSTRACT

An apparatus records moving image data received from an image capturing apparatus. The apparatus records a moving image file by starting recording of the moving image data from the image capturing apparatus in accordance with reception of a recording start command and ending the recording of the moving image data in accordance with reception of a recording end command; and starts creation of a metafile associated with the moving image data based on information concerning the creation of the metafile, the information being received at time of the reception of the recording start command and completes the metafile using metadata received at time of the reception of the recording end command.

### CROSS-REFERENCE TO RELATED APPLICATIONS

This application is a Continuation of International Patent Application No. PCT/JP2023/030287, filed Aug. 23, 2023, which claims the benefit of Japanese Patent Application No. 2022-156463 filed Sep. 29, 2022, both of which are hereby incorporated by reference herein in their entirety.

### BACKGROUND OF THE INVENTION

### Field of the Invention

The present invention relates to a recording apparatus, a control method thereof, a recording medium, and a system.

### Background Art

In recent news reporting sites of broadcasters, news agencies, and the like, IP-based broadcasting systems have been proliferated, and there is also used an IP streaming technology for continuously externally transmitting, via a network, moving image data that is being captured by a video processing apparatus such as a digital still camera or a digital video camera. In addition, additional information files in which various metadata concerning moving image data under image capturing are written are used, thereby more quickly and easily implementing news reporting of high immediacy. In an additional information file, for example, metadata such as the format and the record length of moving image data can be recorded together with the captured moving image data. Also, communication is performed between a portable terminal and a digital video camera, and in a news reporting site, coverage information such as a coverage title or a coverage location can be written in an additional information file. The additional information file is used as, for example, information for more easily searching for desired moving image data in a moving image data server. At this time, the format or the record length of moving image data can be known by browsing various kinds of metadata of the moving image data.

Among metadata (additional information) recorded in an additional information file associated with moving image data, there exists not only additional information set by a user but also additional information to be updated at the start of recording of moving image data and additional information to be updated at the end of recording. In PTL 1, when recording video data (moving image data), metadata associated with the moving image data is simultaneously created and stored in a recording medium in a recording/reproduction apparatus. However, in a case where the recording/reproduction apparatus receives moving image data by IP streaming from an external video processing apparatus, metadata may be insufficient if an additional information file generated in the recording/reproduction apparatus is only stored in association with the received moving image data, like PTL 1. For example, the recording/reproduction apparatus cannot know information indicating that the video processing apparatus that is performing IP streaming records the moving image data unless the video processing apparatus transmits the information. For this reason, such data is insufficient when creating metadata.

### CITATION LIST

### Patent Literature

PTL 1: Japanese Patent Laid-Open No. 2004-363825

### SUMMARY OF THE INVENTION

The present invention has been made in consideration of the above-described problem, and provides a technique of, when recording a moving image file from moving image data received from an external image capturing apparatus, recording a completed metafile associated with the moving image data together.

In order to solve this problem, for example, a recording apparatus according to the present invention has the following configuration.

The present invention in its first aspect provides a recording apparatus including a communication unit and configured to record moving image data received from an image capturing apparatus via the communication unit, comprising: at least one processor and/or circuit; and at least one memory storing computer program, which causes the at least one processor and/or circuit to function as following units: an image file recording unit configured to record a moving image file by starting recording of the moving image data from the image capturing apparatus in accordance with reception of a recording start command via the communication unit and ending the recording of the moving image data in accordance with reception of a recording end command via the communication unit; and a metafile recording unit configured to start creation of a metafile associated with the moving image data based on information concerning the creation of the metafile, the information being received at time of the reception of the recording start command via the communication unit and complete the metafile using metadata received at time of the reception of the recording end command.

The present invention in its second aspect provides a control method of a recording apparatus including communication unit and configured to record moving image data received from an image capturing apparatus via the communication unit, comprising: recording a moving image file by starting recording of the moving image data from the image capturing apparatus in accordance with reception of a recording start command via the communication unit and ending the recording of the moving image data in accordance with reception of a recording end command via the communication unit; and starting creation of a metafile associated with the moving image data based on information concerning the creation of the metafile, the information being received at time of the reception of the recording start command via the communication unit and completing the metafile using metadata received at time of the reception of the recording end command.

The present invention in its third aspect provides a computer-readable recording medium on which is recorded a program for causing a computer to execute the method according to the third aspect.

The present invention in its fourth aspect provides a system comprising an image capturing apparatus connected to a network, and a recording apparatus, wherein the image capturing apparatus comprises: at least one processor and/or circuit; and at least one memory storing computer program, which causes the at least one processor and/or circuit of the image capturing apparatus to function as following units: a first transmission unit configured to transmit moving image data obtained by image capturing by image capturing unit to the recording apparatus; a second transmission unit configured to transmit, upon receiving an instruction to start recording, a recording start command to the recording apparatus and transmit, upon receiving an instruction to end the recording, a recording end command to the recording apparatus; and a third transmission unit configured to transmit, upon receiving the instruction to start the recording, information concerning creation of a metafile associated with the moving image data at time of the start of the recording to the recording apparatus, and transmit, upon receiving the instruction to end the recording, metadata at time of the end of the recording to the recording apparatus, and the recording apparatus comprises: at least one processor and/or circuit; and at least one memory storing computer program, which causes the at least one processor and/or circuit of the recording apparatus to function as following units: an image file recording unit configured to record a moving image file by starting the recording of the moving image data from the image capturing apparatus in accordance with reception of the recording start command and ending the recording of the moving image data in accordance with reception of the recording end command; and a metafile recording unit configured to start creation of a metafile associated with the moving image data based on information concerning the creation of the metafile, the information being received at time of the reception of the recording start command and complete the metafile using the metadata received at time of the reception of the recording end command.

The present invention in its fifth aspect provides a system comprising an image capturing apparatus connected to a network, a recording apparatus, and a control apparatus configured to control the recording apparatus, wherein the control apparatus comprises: at least one processor and/or circuit; and at least one memory storing computer program, which causes the at least one processor and/or circuit of the control apparatus to function as following units: a unit configured to transmit a recording start command to the recording apparatus in accordance with an instruction to start recording from a user, and transmit a recording end command to the recording apparatus in accordance with an instruction to end the recording from the user, the recording apparatus comprises: at least one processor and/or circuit; and at least one memory storing computer program, which causes the at least one processor and/or circuit of the recording apparatus to function as following units: a reception unit configured to receive moving image data from the image capturing apparatus; an image file recording unit configured to record a moving image file by starting recording of the moving image data in accordance with reception of the recording start command and ending the recording of the moving image data in accordance with reception of the recording end command; and a metafile recording unit configured to request, upon receiving the recording start command, information concerning creation of a metafile at the start of the recording from the image capturing apparatus, start the creation of the metafile associated with the moving image data based on information obtained by the request, request, upon receiving the recording end command, metadata at the end of the recording from the image capturing apparatus, and complete the metafile using the metadata obtained by the request, and the image capturing apparatus comprises: at least one processor and/or circuit; and at least one memory storing computer program, which causes the at least one processor and/or circuit of the image capturing apparatus to function as following units: a first transmission unit configured to transmit the moving image data obtained by an image capturing unit to the recording apparatus; and a second transmission unit configured to transmit information concerning creation of a metafile and a metadata in accordance with a requests from the recording apparatus.

Further features of the present invention will become apparent from the following description of exemplary embodiments (with reference to the attached drawings).

### BRIEF DESCRIPTION OF DRAWINGS

The accompanying drawings, which are incorporated in and constitute a part of the specification, illustrate embodiments of the invention and, together with the description, serve to explain principles of the invention.

FIG. 1 is a view exemplarily showing a system configuration according to the first embodiment.

FIG. 2 is a view exemplarily showing the block configuration of a digital video camera.

FIG. 3 is a view showing an example of the format of an XML file.

FIG. 4 is a view exemplarily showing the block configuration of a network recorder.

FIG. 5 is a flowchart exemplarily showing the basic operation of the digital video camera.

FIG. 6 is a view exemplarily showing a setting XML file selection UI.

FIG. 7 is a flowchart exemplarily showing the basic operation of the network recorder.

FIG. 8A is a flowchart exemplarily showing the characteristic operation procedure of the digital video camera according to the first embodiment.

FIG. 8B is a flowchart exemplarily showing the characteristic operation procedure of the network recorder according to the first embodiment.

FIG. 9 is a view exemplarily showing a system configuration according to the second embodiment.

FIG. 10 is a view exemplarily showing the block configuration of a controller.

FIG. 11 is a flowchart exemplarily showing the basic operation of the controller.

FIG. 12A is a flowchart exemplarily showing the characteristic operation of the controller according to the second embodiment.

FIG. 12B is a flowchart exemplarily showing the characteristic operation of a network recorder according to the second embodiment.

FIG. 12C is a flowchart exemplarily showing the characteristic operation of a digital video camera 100 according to the second embodiment.

FIG. 13A is a view showing an example of recording start time information metadata of an XML file for the digital video camera.

FIG. 13B is a view showing an example of recording start time information metadata of the XML file for the network recorder.

### DESCRIPTION OF EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

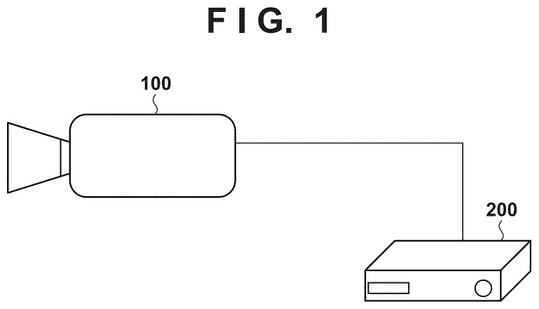

FIG. 1 is a view showing an example of a system configuration according to this embodiment. The system includes a digital video camera 100 that captures a moving image and creates and transmits metadata, and a network recorder 200 that stores the moving image data and the metadata transmitted from the digital video camera 100. In this embodiment, the digital video camera 100 and the network recorder 200 are connected by a local area network (LAN). The digital video camera 100 and the network recorder 200 may be connected via a network switch or the like. The communication protocol is an Internet protocol, but the type is not particularly limited. In addition, the connection form can be wired or wireless.

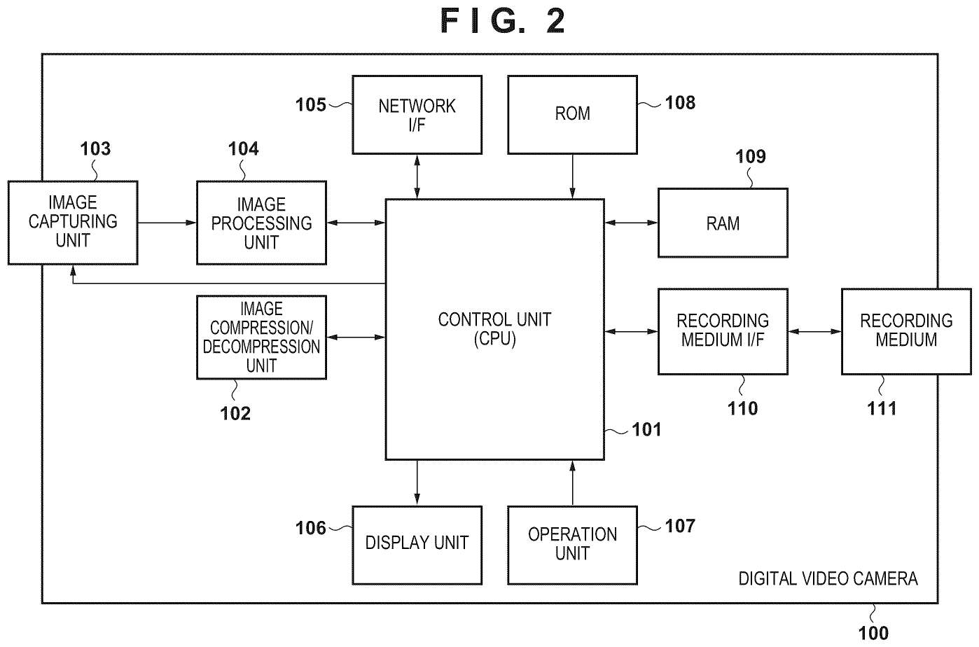

FIG. 2 is a view showing the block configuration of the digital video camera 100. The digital video camera 100 includes a control unit 101, an image compression/decompression unit 102, an image capturing unit 103, an image processing unit 104, a network I/F 105, a display unit 106, an operation unit 107, a ROM 108, a RAM 109, and a recording medium I/F 110. These constituent elements are driven by power obtained by rectifying AC power supplied from the outside into a predetermined voltage or power supplied from an internal battery (not shown).

The control unit 101 is formed by a processor such as a CPU and controls the entire apparatus. More specifically, the control unit 101 deploys a program recorded in the ROM 108 to the RAM 109 and executes it, thereby performing control of each constituent part and arithmetic processing and executing processing according to the flowcharts to be described later. The ROM 108 is a nonvolatile memory, and stores programs to be executed by the control unit 101 and various kinds of settings.

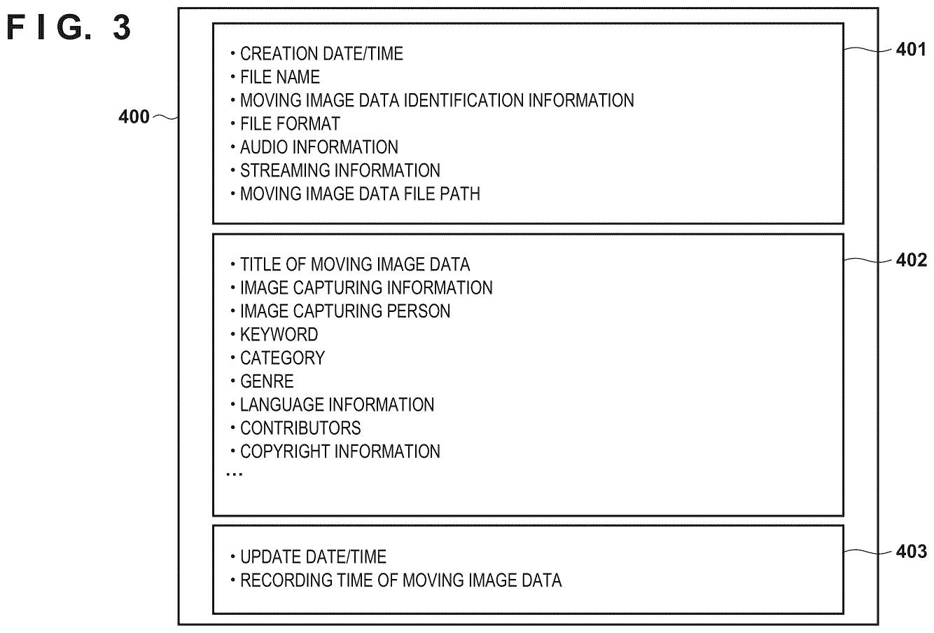

The RAM 109 is a volatile memory used as the work memory of the control unit 101. The RAM 109 is also used as a video random access memory (VRAM) that temporarily stores data to be displayed on the display unit 106 or image data captured by the image capturing unit 103 and processed by the image processing unit 104 or image data read out from a recording medium 111 to perform compression processing or decompression processing by the image compression/decompression unit 102. The RAM 109 is also used to temporarily store an extensible markup language (XML) file to be recorded in association with a captured image or metadata to be written to the XML file. The XML file is generated based on the control of the control unit 101. To generate the XML file, metadata (additional information) included in a setting XML file received from an external apparatus via the network I/F 105 or a setting XML file recorded in the recording medium 111 and metadata that can be acquired at the start or completion of recording. Details of a metadata configuration included in the XML file will be described later with reference to FIG. 3.

The control unit 101 also functions as a display control unit because it generates display data and controls the display timing for the display unit 106. Also, the control unit 101 functions as a record control unit because it controls data record or read for the recording medium 111 via the recording medium I/F 110. The control unit 101 may be formed by a plurality of processors. The control unit 101 may be imparted with the function of another constituent part (for example, the image compression/decompression unit 102 or the image processing unit 104) and thus integrally formed. Alternatively, the control unit 101 may be imparted with the function of a part of another constituent part.

The recording medium 111 configured to record image data can be attached to the digital video camera 100. For this purpose, the digital video camera 100 includes the recording medium interface (I/F) 110. The recording medium I/F 110 has a slot to which the detachable recording medium 111 such as a memory card can be inserted. FIG. 2 shows an example in which the recording medium 111 is attached to the recording medium I/F 110. A description will be made assuming that the digital video camera 100 according to this embodiment is configured to record image data in the detachable recording medium 111. There is also a possible configuration in which moving image data is recorded in a recording medium that is undetachable and is incorporated in the digital video camera 100.

The recording medium 111 is used to record an XML file or moving image data obtained by capturing an image by the image capturing unit 103 and performing various kinds of processing by the image processing unit 104 and the image compression/decompression unit 102. Note that the type of the recording medium is not particularly limited and, for example, a recording medium such as an SD card (SD Memory Card)® or a CFExpress card® can be applied to the recording medium 111.

The image processing unit 104 performs predetermined pixel interpolation, resize processing, or color conversion processing for image data captured by the image capturing unit 103. Also, the image processing unit 104 performs predetermined arithmetic processing using the captured image data. The control unit 101 performs various kinds of control (exposure control, auto white balance processing, and the like) concerning image capturing by the image capturing unit 103 based on the obtained operation result.

The image compression/decompression unit 102 performs processing of compression-coding image data after image processing by the image processing unit 104 and decompression (decoding) processing for image data read out from the recording medium 111.

The image capturing unit 103 includes an imaging lens (including a zoom lens and a focus lens) and an image capturing element. Based on the control of the control unit 101, the image capturing unit 103 captures an object, generates data such as still image data or moving image data, and outputs it.

Based on the control of the control unit 101, the network I/F 105 transmits/receives data to/from an external apparatus such as an external camera, a personal computer, a smartphone, or a tablet. By the network I/F 105, it is possible to transmit setting information and operation information of the digital video camera 100 to the external apparatus and receive, from the external apparatus, a command for operating the digital video camera 100 or an XML file to be recorded together with image data. The received data is stored in the RAM 109. Data that can be transmitted/received includes digital image data and analog video signals. In addition, the network I/F 105 transmits/receives data to/from the network recorder 200 based on the control of the control unit 101. By the network I/F 105, it is possible to transmit an XML file created by the digital video camera 100 or moving image data to the network recorder 200. Note that in this embodiment, if the network recorder 200 is connected, the control unit 101 consecutively continuously transmits moving image data obtained by capturing an image by the image capturing unit 103 and performing various kinds of processing by the image processing unit 104 and the image compression/decompression unit 102 to the network recorder 200 via the network I/F 105.

The display unit 106 is a display configured to display, based on the control of the control unit 101, various kinds of setting states, an image that is being captured by the image capturing unit 103, or an image read out from the recording medium and reproduced. The display unit 106 is formed as a display in a look-in-type viewfinder or a vari-angle liquid crystal monitor.

The operation unit 107 is an operation unit that accepts an operation from the user, including a power switch configured to supply power to the digital video camera 100, an image capturing start button, and a mode switch button capable of switching the mode to a camera mode (image capturing mode) or a reproduction mode. Note that if a touch panel is included in the operation unit 107, the touch panel can be of any one of various types of touch panels such as a resistance film type, an electrostatic capacitance type, a surface acoustic wave type, an infrared type, an electromagnetic induction type, an image recognition type, and an optical sensor type.

FIG. 3 shows an example of the configuration of metadata (additional information) included in an XML file recorded in association with moving image data in this embodiment. An XML file 400 is formed by metadata 401 recorded based on information read out at the start of recording, metadata 402 set by the user, and metadata 403 recorded based on information read out at the end of recording. Each piece of information of the metadata 401 is information determined at the start of recording of moving image data, and is additional information that is not changed after the start of recording. Examples of the information of the metadata 401 are a creation date/time, a file name, moving image data identification information, a file format, and audio information. Each piece of information of the metadata 402 is additional information set by the user, and examples are a moving image data title, image capturing information, an image capturing person, a keyword, a category, a genre, language information, and copyright information. Each piece of information of the metadata 403 is additional information determined at the end of recording of moving image data, and is information that cannot be read out at the start of recording of the moving image data. Examples are an update date/time and the record length (the recording time or the number of frames) of moving image data.

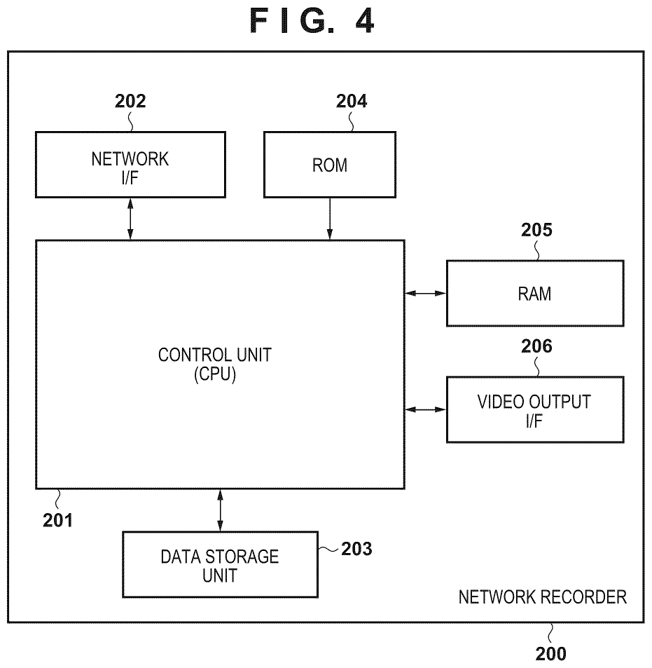

FIG. 4 is a block diagram of the network recorder 200. The network recorder 200 includes a control unit 201, a network I/F 202, a data storage unit 203, a ROM 204, a RAM 205, and a video output I/F 206. These constituent elements are driven by power obtained by rectifying AC power supplied from the outside into a predetermined voltage or power supplied from an internal battery (not shown).

The control unit 201 is formed by a processor such as a CPU and controls the entire apparatus. More specifically, the control unit 201 deploys a program recorded in the ROM 204 to the RAM 205 and executes it, thereby performing control of each constituent part and arithmetic processing and executing processing shown in the flowcharts to be described later.

The data storage unit 203 is a storage unit configured to store, as a file, moving image data transmitted from the digital video camera 100 or XML data generated in the network recorder 200, and is formed by, for example, a mass recording device such as a solid state drive (SSD) or a hard disk drive (HDD).

The ROM 204 is a nonvolatile recording medium, and stores programs to be executed by the control unit 201 and various kinds of setting information.

The RAM 205 is a volatile recording medium used as the work memory of the control unit 201. The RAM 205 is also used as a VRAM. Also, the control unit 201 functions as a video control unit because it controls video output to a video output device such as a display via the video output I/F 206. The control unit 201 may be formed by a plurality of processors. The control unit 201 may be imparted with the function of another constituent part (for example, the data storage unit 203) and thus integrally formed. Alternatively, the control unit 201 may be imparted with the function of a part of another constituent part.

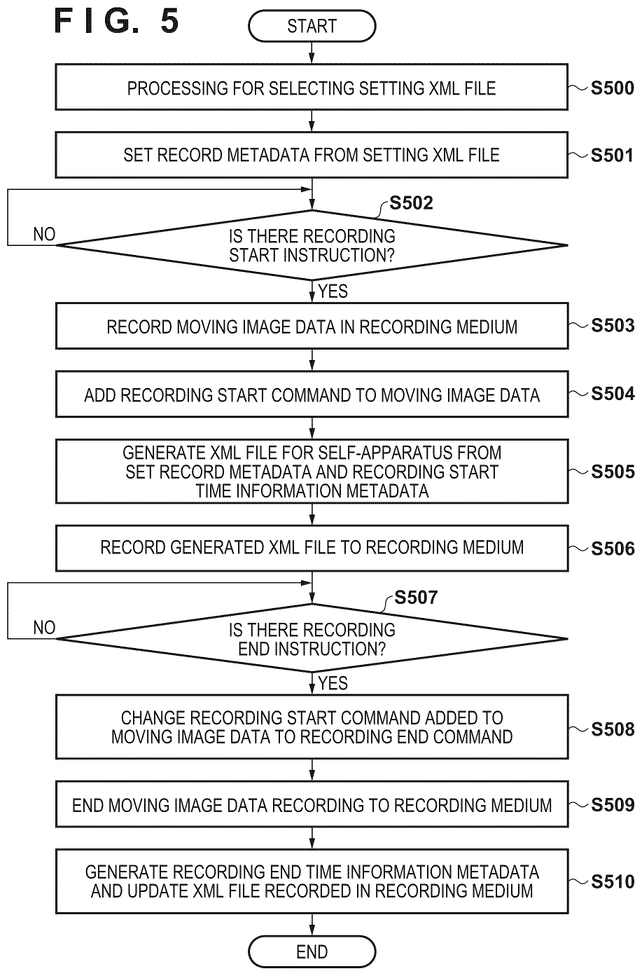

FIG. 5 is an operation flowchart showing the basic operation of the digital video camera 100. The control unit 101 reads out a program stored in the ROM 108, deploys it to the RAM 109, and executes the deployed program, thereby performing control of each unit and arithmetic processing associated with the operation flowchart. Upon detecting that the digital video camera 100 is set in the camera mode (image capturing mode) by a user operation on the operation unit 107, the control unit 101 starts processing shown in FIG. 5. Note that in this embodiment, if the digital video camera 100 has been connected to the network recorder 200 at the start of the procedure shown in FIG. 5, the digital video camera 100 is consecutively continuously transmitting moving image data to the connected network recorder 200. The processing shown in FIG. 5 is merely an example, and the order is not limited.

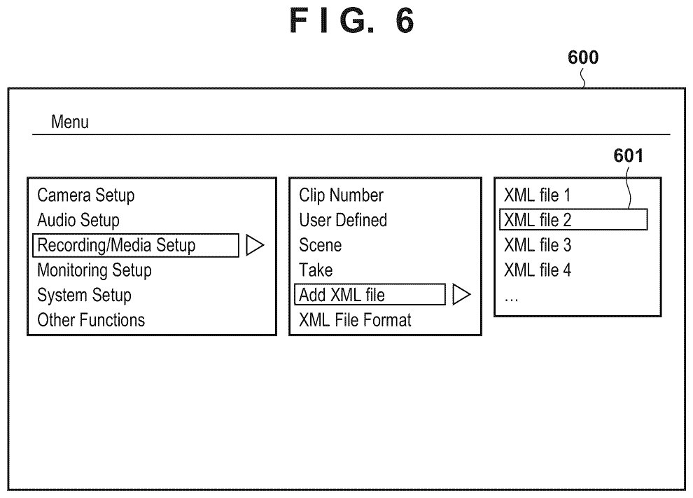

In step S500, the control unit 101 detects a user operation on a menu button included in the operation unit 107, thereby causing the display unit 106 to display a menu 600 as shown in FIG. 6. The user can select, from items of the menu 600, a setting XML file by operating a selection cursor 601 using a 4-way selector included in the operation unit 107. When the setting XML file is selected by the user, the process advances to step S501.

Note that FIG. 6 shows that “Recording/Media Setup” is selected in the main menu, “Add XML file” is selected in a sub-menu displayed in accordance with the selection, and “XML file 2” is selected as an XML file from a sub-menu.

In step S501, the control unit 101 reads out the contents of the setting XML file selected in step S500 from the recording medium 111 to the RAM 109 via the recording medium I/F 110. The control unit 101 then writes, as record metadata, only information necessary for an XML file to be recorded in association with moving image data to the RAM 109 in accordance with the structure of the XML file.

In step S502, the control unit 101 determines whether a moving image data recording start instruction from the user is input via the operation unit 107. Upon determining that the recording start instruction is input, the control unit 101 advances the process to step S503. Upon determining that the recording start instruction is not input, the control unit 101 returns the process to step S502 to wait for the input. That is, the control unit 101 repeats the processing of step S502 until the input of the moving image recording start instruction is detected.

In step S503, in accordance with the input of the recording start instruction in step S502, the control unit 101 writes (records), in the recording medium 111, moving image data obtained by capturing an image by the image capturing unit 103 and performing various kinds of processing by the image processing unit 104 and the image compression/decompression unit 102.

In step S504, the control unit 101 reads out the moving image data from the RAM 109, transmits it to the network recorder 200 via the network I/F 105, and also transmits a recording start command. Note that the network recorder 200 that has received the recording start command starts recording the received moving image data as a moving image file in the data storage unit 203.

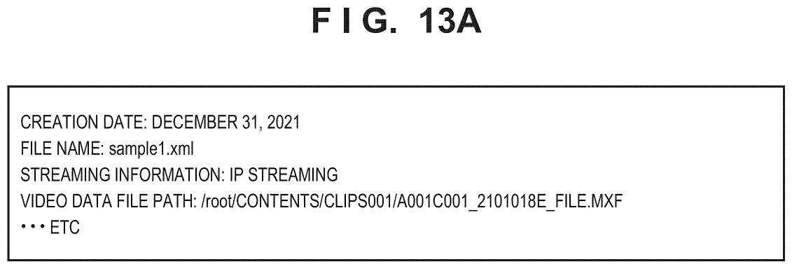

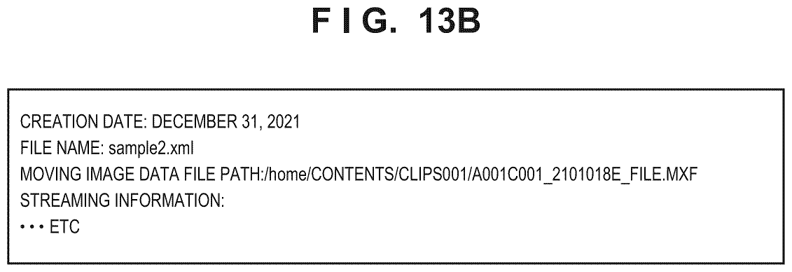

In step S505, the control unit 101 writes, as recording start time information metadata, information that can be acquired at the start of recording of the moving image data in accordance with generation of the moving image data to the RAM 109. Note that if the moving image data is recorded in the network recorder 200, the recording start time information metadata includes information indicating that the moving image data is being transmitted to the network recorder 200. Then, the control unit 101 writes the XML file to the RAM 109 using the recording start time information metadata written to the RAM 109 in step S505 and the record metadata written to the RAM 109 in step S501. That is, in the XML file shown in FIG. 3, the recording start time information metadata is set as the metadata 401 as shown in FIG. 13A, and the record metadata is set as the metadata 402, and the XML file is then written to the RAM 109. At this time, the XML file may be generated by setting each piece of information of the metadata 403 to blank or 0, or the XML file that does not include the metadata 403 may be generated.

In step S506, the control unit 101 reads out the XML file generated in step S505 from the RAM 109, and writes it to the recording medium 111 via the recording medium I/F 110 in association with the moving image data started to be recorded in the recording medium 111 in step S503.

In step S507, the control unit 101 determines whether a moving image data recording end instruction from the user is input via the operation unit 107. Upon determining that the recording end instruction is input, the control unit 101 advances the process to step S508. On the other hand, upon determining that the recording end instruction is not input, the control unit 101 returns the process to step S507 to continue moving image data recording until the recording end instruction is input.

In step S508, the control unit 101 overwrites the recording end command on the recording start command written to the RAM 109 in step S504. Note that upon receiving the recording end command, the network recorder 200 connected to the digital video camera 100 ends recording of the moving image data.

In step S509, the control unit 101 writes the moving image data that is captured until the input of the recording end instruction but is not stored to the recording medium 111 as moving image data. The control unit 101 then writes or updates the header of the moving image data and completes the moving image data recording processing.

In step S510, the control unit 101 writes information that can be acquired at the end of recording of the moving image data as recording end time information metadata to the RAM 109. Then, the control unit 101 reads out the XML file recorded in the recording medium 111 in step S506, adds the recording end time information metadata as the metadata 403 to the XML file, and records the XML file in the recording medium 111. Since each piece of information of the metadata 403 determined at the end of recording is not recorded in the XML file written to the recording medium 111 in step S506, information that should be recorded is not included in the XML file. Hence, the control unit 101 overwrites the XML file in which each piece of information of the metadata 403 is described in step S510 on the XML file recorded in the recording medium 111 in step S506, and completes recording of the XML file. Note that the processing of step S510 may be executed, without waiting for completion of recording of the moving image data, at the timing at which the recording end time information metadata can be generated, that is, at the timing of moving image data recording completion at which the information of the recording time of the moving image data can be acquired. Hence, recording of the XML file may be completed before completion of recording of the moving image data.

By executing the above-described steps, the digital video camera 100 can store the moving image data and the XML file associated with the moving image data in the recording medium 111.

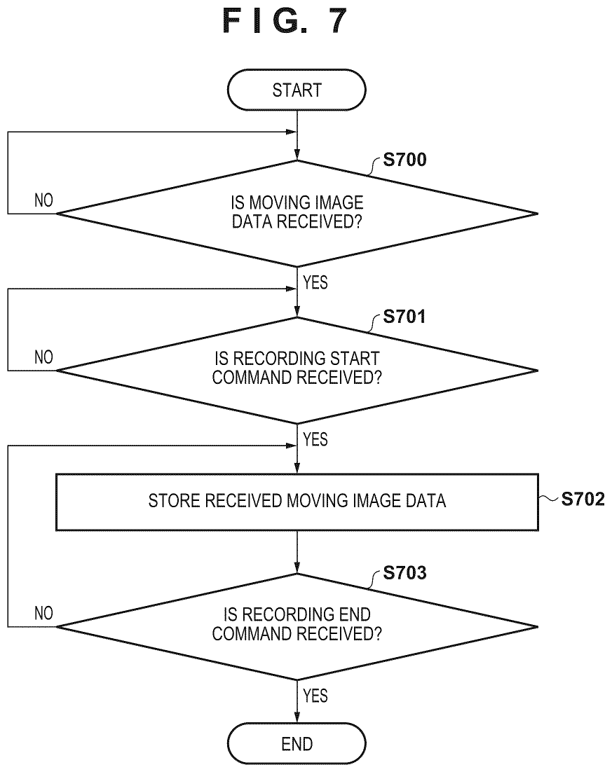

FIG. 7 is an operation flowchart showing the basic operation of the network recorder 200. The control unit 201 reads out a program stored in the ROM 204, deploys it to the RAM 205, and executes the deployed program, thereby performing control of each unit and arithmetic processing associated with the operation flowchart. Note that the processing shown in FIG. 7 is merely an example, and the order is not limited.

In step S700, the control unit 201 determines whether moving image data is received from the digital video camera 100 via the network I/F 202. Upon determining that moving image data is received, the control unit 201 advances the process to step S701. Upon determining that moving image data is not received, the control unit 201 returns the process to step S700. That is, the control unit 201 repeats the processing of step S700 until moving image data is received.

In step S701, the control unit 201 determines whether a recording start command is received from the digital video camera 100 via the network I/F 202. Upon determining that the recording start command is received, the control unit 201 advances the process to step S702. Upon determining that the recording start command is not received, the control unit 201 returns the process to step S701. That is, the control unit 201 repeats the processing of step S701 until the recording start command is received.

In step S702, the control unit 201 reads out, from the RAM 109, the moving image data received from the digital video camera 100 via the network I/F 202, and writes it to the data storage unit 203. Note that if the moving image data is consecutively continuously received from the digital video camera 100, the control unit 201 reads out the received moving image data from the RAM 109, and sequentially continuously writes it to the data storage unit 203.

In step S703, the control unit 201 reads out, from the RAM 109, data received from the digital video camera 100 via the network I/F 202, and determines whether the data is a recording end command. Upon determining that the recording end command is received, the control unit 201 ends writing the moving image data to the data storage unit 203, and ends recording processing of the moving image file. Also, upon determining that the recording end command is not received, the control unit 201 returns the process to S702. That is, the control unit 201 repeats the processing of steps S702 and S703 until the recording end command is received.

By executing the above-described steps, the network recorder 200 can store, in the data storage unit 203, the moving image data received from the digital video camera 100.

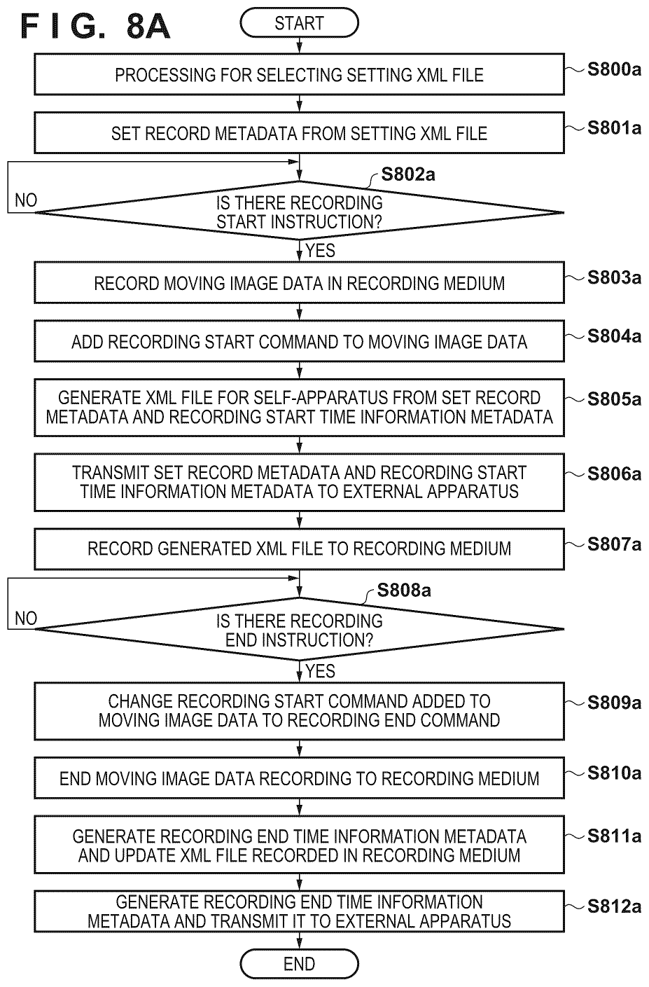

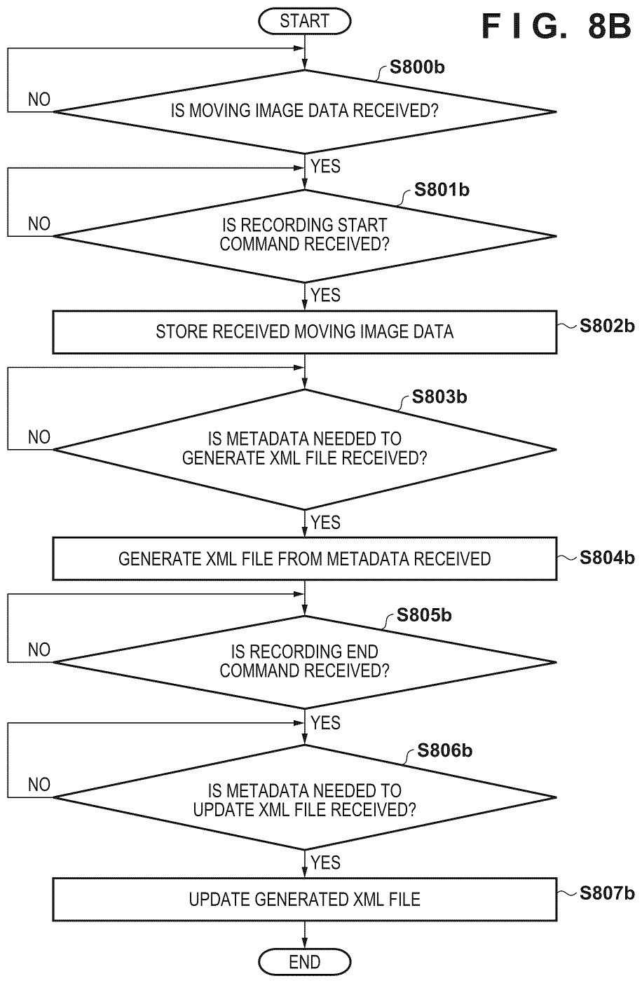

FIG. 8A is an operation flowchart showing the characteristic operation of the digital video camera 100 according to this embodiment. The control unit 101 reads out a program stored in the ROM 108, deploys it to the RAM 109, and executes the deployed program, thereby performing control of each unit and arithmetic processing associated with the operation flowchart. If the digital video camera 100 is set in the camera mode (image capturing mode) by a user operation on the operation unit 107, the control unit 101 starts processing shown in FIG. 8A. Note that the processing shown in FIG. 8A is merely an example, and the order is not limited.

Steps S800a to S805a in FIG. 8A are the same as steps S500 to S505 in FIG. 5, and a description thereof will be omitted.

In step S806a, the control unit 101 writes information that can be acquired at the start of recording of moving image data as recording start time information metadata to the RAM 109. Note that if the moving image data is recorded in the camera, the recording start time information metadata also includes information indicating that the moving image data is recorded in the camera. Then, the control unit 101 transmits the recording start time information metadata written to the RAM 109 in step S806a and the record metadata written to the RAM 109 in step S801a to the network recorder 200 via the network I/F 105. Note that if a user operation interrupts during transmission of the recording start time information metadata or the record metadata, divisional transmission may be performed by preferring the user operation first and transmitting the rest after processing for the user operation.

In steps S807a to S811a, the control unit 101 performs the same processing as in steps S506 to S510 of FIG. 5 using the XML file for the digital video camera 100 created in step S805a. Note that in step S809a, the control unit 101 also performs processing of transmitting the recording end command to the network recorder 200.

In step S812a, the control unit 101 writes information that can be acquired at the time of the end of recording of the moving image data as recording end time information metadata to the RAM 109. Then, in step S813a, the control unit 101 transmits the recording end time information metadata written in step S812a to the network recorder 200 via the network I/F 105. Note that the processing of step S812a is executed, without waiting for completion of recording of the moving image data, at the timing at which the recording end time information metadata can be generated, that is, at the timing of moving image data recording completion at which the information of the recording time of the moving image data can be acquired. Hence, the recording end time information metadata may be transmitted to the network recorder 200 before recording of the moving image data is completed.

FIG. 8B is an operation flowchart showing the characteristic operation of the network recorder 200 according to this embodiment. The control unit 201 reads out a program stored in the ROM 204, deploys it to the RAM 205, and executes the deployed program, thereby performing control of each unit and arithmetic processing associated with the operation flowchart. Note that the processing shown in FIG. 8B is merely an example, and the order is not limited.

Steps S800b to S802b in FIG. 8B are the same as steps S700 to S702 in FIG. 7, and a description thereof will be omitted.

In step S803b, the control unit 201 reads out, from the RAM 109, the data received from the digital video camera 100 via the network I/F 202. The control unit 201 determines whether the readout data are the record metadata and the recording start time information metadata transmitted in step S806a. Upon determining that the record metadata and the recording start time information metadata are received, the control unit 201 advances the process to step S804b. Upon determining that the record metadata and the recording start time information metadata are not received, the control unit 201 returns the process to step S803b. That is, the control unit 201 repeats the processing of step S803b until the record metadata and the recording start time information metadata are received.

In step S804b, the control unit 201 generates an XML file using the record metadata and the recording start time information metadata received in step S803b, and writes it to the data storage unit 203. That is, in the XML file shown in FIG. 3, the recording start time information metadata is set as the metadata 401 as shown in FIG. 13B, and the record metadata is set as the metadata 402, and the XML file is then written to the data storage unit 203. At this time, the XML file may be generated by setting each piece of information of the metadata 403 to blank or 0, or the XML file that does not include the metadata 403 may be generated.

In step S805b, the control unit 201 determines whether a recording end command is received from the digital video camera 100 via the network I/F 202. Upon determining that the recording end command is received, the control unit 201 ends the recording of the moving image data and advances the process to step S806b. Upon determining that the recording end command is not received, the control unit 201 returns the process to step S805b to wait for reception of the command.

In step S806b, the control unit 201 reads out, from the RAM 109, the data received from the digital video camera 100 via the network I/F 202. The control unit 201 then determines whether the data is the recording end time information metadata transmitted from the digital video camera 100 in step S812a. Upon determining that the recording end time information metadata is received, the control unit 201 advances the process to step S807b. Upon determining that the recording end time information metadata is not received, the control unit 201 returns the process to step S806b. That is, the control unit 201 repeats the processing of step S806b until the recording end time information metadata is received.

In step S807b, the control unit 201 reads out the XML file written to the data storage unit 203 in step S804b. Then, the control unit 201 adds the recording stop time information metadata received from the digital video camera 100 in step S806b as the metadata 403 to the XML file to complete the XML file, and writes (overwrites) it to the data storage unit 203. At this time, the control unit 201 calculates the moving image data recording time from the reception time of the recording start command received in step S801b and the reception time of the recording stop command received in step S805b, adds the time information to the XML file, and writes it to the data storage unit 203. Since each piece of information of the metadata 403 determined at the end of recording is not recorded in the XML file written to the data storage unit 203 in step S804b, information that should be recorded is not included in the XML file. Hence, the control unit 201 overwrites the XML file in which each piece of information of the metadata 403 is described in step S804b on the XML file recorded in the data storage unit 203 in step S804b, and completes recording of the XML file. Note that the processing of step S804b may be executed, without waiting for completion of recording of the moving image data, at the timing at which the recording stop time information metadata is received. Hence, recording of the XML file may be completed before completion of recording of the moving image data.

As described above, the digital video camera 100 continuously transmits moving image data to the network recorder 200 and transmits a command to instruct the timing of recording the moving image data in the network recorder 200 and metadata necessary for creating an XML file. Even to end the recording of the moving image data, the digital video camera 100 transmits metadata to be used in the network recorder 200. Thus, the network recorder 200 can store the moving image data captured by the digital video camera 100 as a moving image file, and generate an XML file from the metadata from the start to the end of recording of the moving image data and store it in association with the moving image file. Note that in this embodiment, the setting XML file is set by the digital video camera 100 in advance, but it may be set by the network recorder 200.

### Second Embodiment

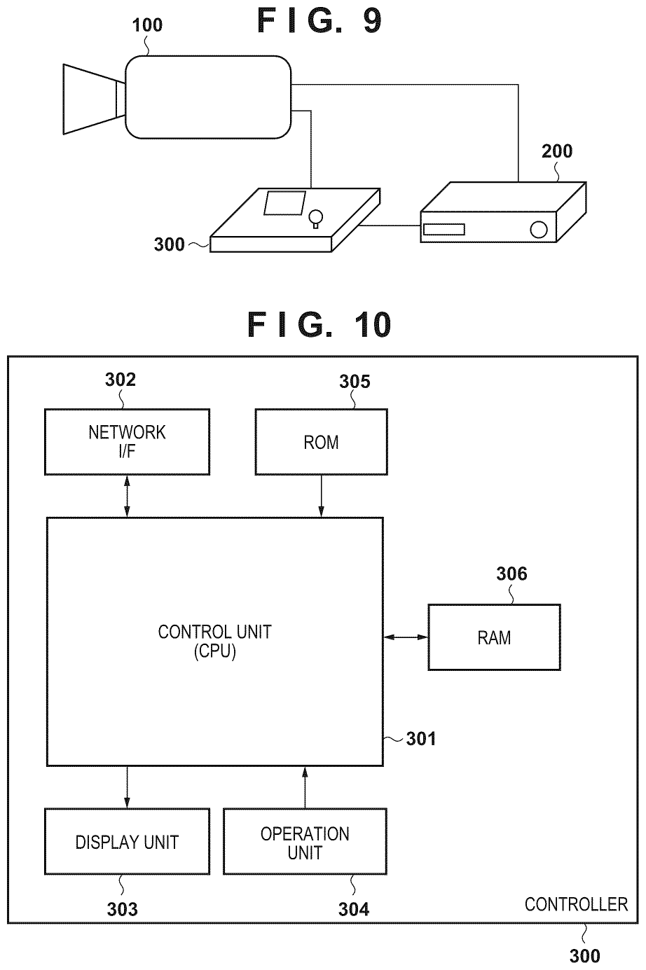

The second embodiment will be described below. FIG. 9 is a view showing an example of a system configuration according to the second embodiment. The system includes a controller 300 in addition to a digital video camera 100 that captures a moving image and creates and transmits metadata, and a network recorder 200 that stores the moving image data and the metadata transmitted from the digital video camera 100. The controller 300 remotely controls the network recorder 200 by a command transmission function to the network recorder 200.

The digital video camera 100 and the network recorder 200 have the same configurations as those shown in FIGS. 2 and 4 described in the first embodiment, and a description thereof will be omitted. The controller 300 according to the second embodiment is used to externally perform the processing of steps S701 and S703 shown in FIG. 7 in the first embodiment. Note that the digital video camera 100 executes the same procedure as the procedure described with reference to FIG. 8A. In the second embodiment, the digital video camera 100, the network recorder 200, and the controller 300 are connected by a local area network (LAN). Note that the digital video camera 100, the network recorder 200, and the controller 300 may be connected via a network switch or the like. These devices may be connected by a Universal Serial Bus (USB), a High-Definition Multimedia Interface (HDMI®), a Serial Digital Interface (SDI), or the like. If the devices are connected by a USB, any one of a control transfer method, a bulk transfer method, an interrupt transfer method, and an isochronous transfer method can be used. If the devices are connected by an HDMI®, a Transition Minimized Differential Signaling (TMDS) method may be used. In addition, the communication protocol between these devices is not particularly limited, and the connection form can be wired or wireless.

FIG. 10 is a block diagram of the controller 300. The controller 300 includes a control unit 301, a network I/F 302, a display unit 303, an operation unit 304, a ROM 305, and a RAM 306. These constituent elements are connected such that these can exchange data with each other. Also, the constituent elements are driven by power supplied from a plug socket or power supplied from a battery.

The control unit 301 is a system control unit such as a CPU that control the whole system of the controller 300. The control unit 301 deploys a program recorded in the ROM 305 to the RAM 306 and executes the deployed program, thereby performing control of each constituent part and arithmetic processing and executing flowcharts to be described later. Note that the control unit 301 also functions as a display control unit because it generates display data and controls the display timing for the display unit 303. Also, the control unit 301 may be formed by a plurality of processors. The control unit 301 may be imparted with the function of another constituent part (for example, the operation unit 304) and thus integrally formed. Alternatively, the control unit 301 may be imparted with the function of a part of another constituent part.

The ROM 305 is a nonvolatile recording medium, and stores programs to be executed by the control unit 301 and various kinds of settings.

The RAM 306 is a volatile recording medium used as the work memory of the control unit 301. The RAM 306 is also used as a VRAM that temporarily stores data to be displayed on the display unit 303

Based on the control of the control unit 301, the network I/F 302 transmits/receives data to/from the connected network recorder 200. By the network I/F 302, a command for operating the network recorder 200 can be transmitted to the network recorder 200. Also, the network I/F 302 receives setting information and operation information of the network recorder 200 from the network recorder 200 and stores the information in the RAM 306.

The display unit 303 is a display configured to display, based on the control of the control unit 301, various kinds of setting states or received setting information of the network recorder 200.

The operation unit 304 is an operation unit that accepts an operation from the user, including a power switch configured to supply power to the controller 300 and an operation button used to operate the digital video camera 100 or the network recorder 200. When the user operates the operation unit 304, the partner of communication with the controller 300 can be switched. In addition, to record moving image data, the user inputs a recording start instruction or a recording stop instruction by operating the operation unit 304, thereby performing control of the start and end of recording of moving image data for the selected communication destination. Note that if a touch panel is included in the operation unit 304, the touch panel can be of any one of various types of touch panels such as a resistance film type, an electrostatic capacitance type, a surface acoustic wave type, an infrared type, an electromagnetic induction type, an image recognition type, and an optical sensor type.

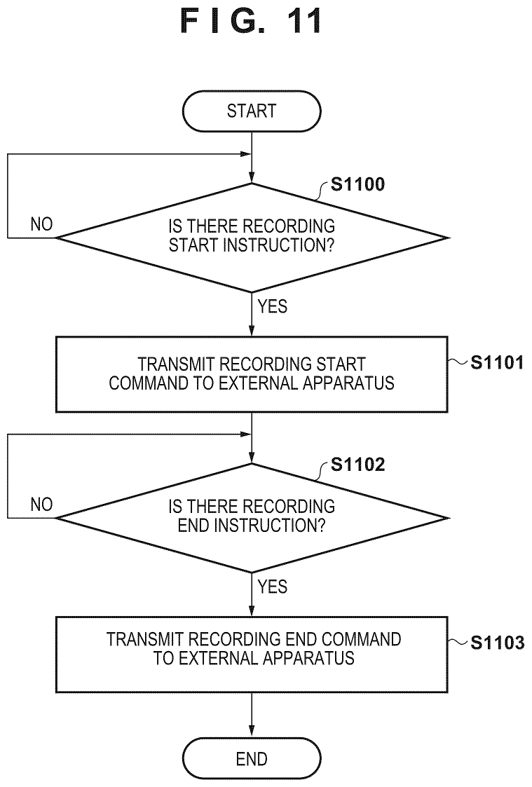

FIG. 11 is an operation flowchart showing the basic operation of the controller 300. The control unit 301 reads out a program stored in the ROM 305, deploys it to the RAM 306, and executes the deployed program, thereby performing control of each unit and arithmetic processing associated with the operation flowchart. Note that the processing shown in FIG. 11 is merely an example, and the order is not limited.

In step S1100, the control unit 301 determines whether a moving image data recording start instruction from a user is input via the operation unit 304. Upon determining that the recording start instruction is input, the control unit 301 advances the process to step S1101. Upon determining that the recording start instruction is not input, the control unit 301 returns the process to step S1100. That is, the control unit 301 repeats the processing of step S1100 until the recording start instruction is input.

In step S1101, the control unit 301 transmits a recording start command to the network recorder 200 via the network I/F 302.

In step S1102, the control unit 301 determines whether a moving image data recording end instruction from the user is input via the operation unit 304. Upon determining that the recording end instruction is input, the control unit 301 advances the process to step S1103. Upon determining that the recording end instruction is not input, the control unit 301 returns the process to step S1102. That is, the control unit 301 repeats the processing of step S1102 until the recording end instruction is input.

In step S1103, the control unit 301 transmits a recording end command to the network recorder 200 via the network I/F 302, and ends the processing.

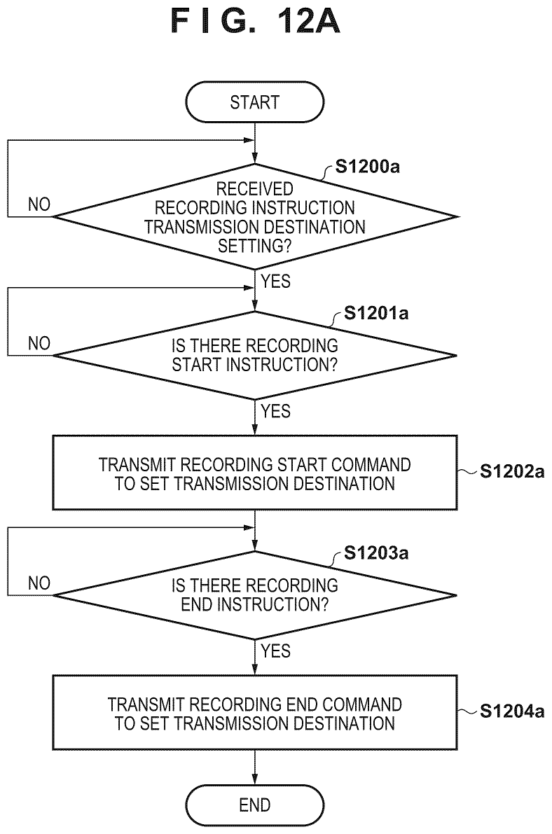

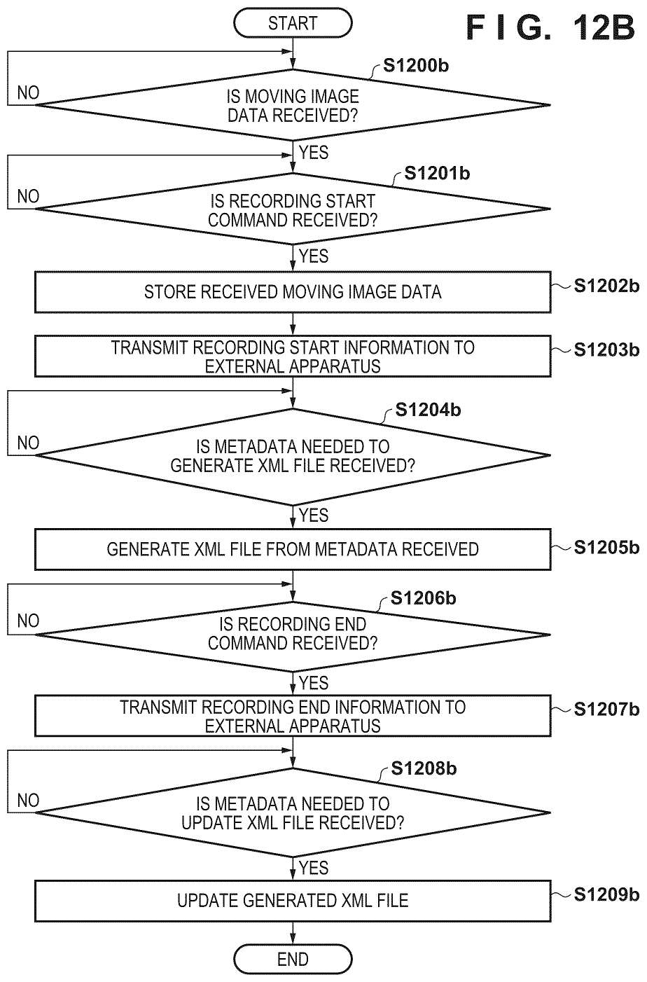

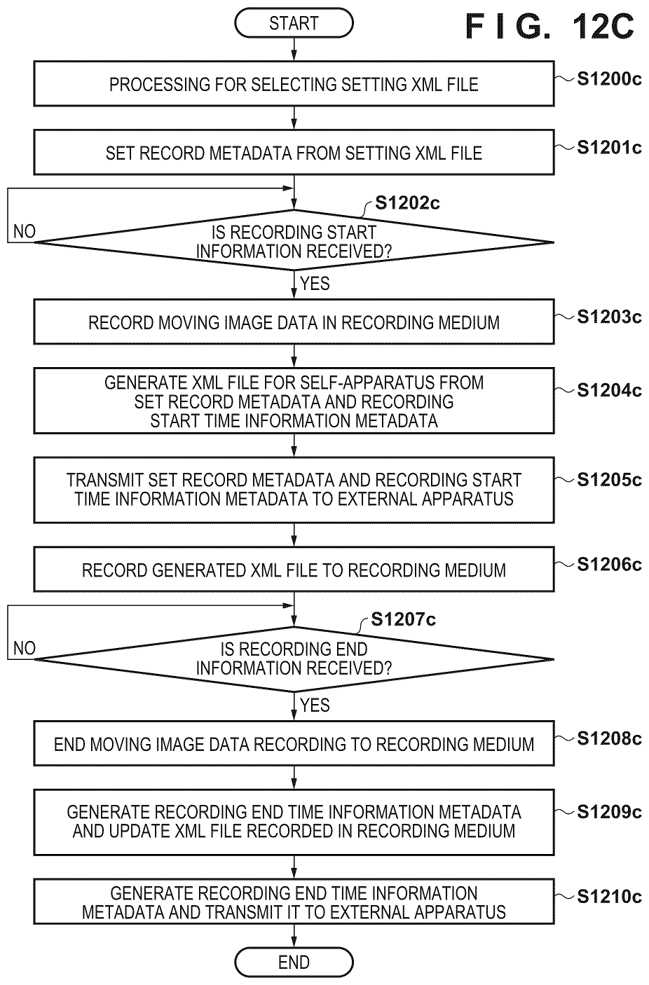

FIG. 12A is an operation flowchart showing the characteristic operation of the controller 300 according to the second embodiment.

In step S1200a, the control unit 301 of the controller 300 determines whether an instruction to select a transmission destination device to which a command concerning moving image data recording is to be transmitted is input via the operation unit 304. Upon determining that the instruction to select the transmission destination device is input, the control unit 301 advances the process to step S1201a. Upon determining that the instruction to select the transmission destination device is not input, the control unit 301 returns the process to step S1200a. That is, the control unit 301 repeats the processing of step S1200a until the instruction to select the transmission destination device is input. Note that the number of transmission destination devices is not limited to one, there may be a plurality of transmission destination devices, and the number is not particularly limited.

In step S1201a, the control unit 301 determines whether a moving image data recording start instruction from the user is input via the operation unit 304. Upon determining that the recording start instruction is input, the control unit 301 advances the process to step S1202a. Upon determining that the recording start instruction is not input, the control unit 301 returns the process to step S1201a. That is, the control unit 301 repeats the processing of step S1201a until the moving image data recording start instruction is input.

In step S1202a, the control unit 301 transmits, via the network I/F 302, a recording start command to the transmission destination device (the network recorder 200 in this embodiment) set in step S1200a. Note that if a plurality of transmission destination devices are selected in step S1200a, the control unit 301 transmits the recording start command to all the transmission destination devices, but the timing of transmitting the recording start command may be different.

In step S1203a, the control unit 301 determines whether a moving image data recording end instruction from the user is input via the operation unit 304. Upon determining that the recording end instruction is input, the control unit 301 advances the process to step S1204a. Upon determining that the recording end instruction is not input, the control unit 301 returns the process to step S1203a. That is, the control unit 301 repeats the processing of step S1203a until the moving image data recording end instruction is input.

In step S1204a, the control unit 301 transmits a recording end command to the transmission destination device set in step S1200a via the network I/F 302, and ends the processing. Note that if a plurality of transmission destination devices are selected in step S1200a, the control unit 301 transmits the recording end command to all the transmission destination devices, but the timing of transmitting the recording end command may be different.

By executing the above-described steps, the controller 300 can control, from a remote site, the network recorder 200 to cause it to perform the start and end of recording of moving image data.

FIG. 12B is an operation flowchart showing the characteristic operation of the network recorder 200 according to the second embodiment.

In step S1200b, a control unit 201 of the network recorder 200 determines whether moving image data is received from the digital video camera 100. Upon determining that moving image data is received from the digital video camera 100, the control unit 201 advances the process to step S1201b. Upon determining that moving image data is not received from the digital video camera 100, the control unit 201 returns the process to step S1200b.

In step S1201b, the control unit 201 determines whether a recording start command is received from the controller 300 via a network I/F 202. Upon determining that the recording start command is received, the control unit 201 advances the process to step S1202b. Upon determining that the recording start command is not received, the control unit 201 returns the process to step S1201b. That is, the control unit 201 repeats the processing of step S1201b until the recording start command is received.

In step S1202b, the control unit 201 starts recording the received moving image data in a data storage unit 203.

In step S1203b, to request information concerning metafile creation from the digital video camera 100, the control unit 201 transmits, via the network I/F 202, information (recording start information) indicating that recording is started. The recording start information is information serving as a trigger for causing the digital video camera 100 to transmit metadata. The digital video camera 100 receives the recording start time information from the network recorder 200 and thus starts creating metadata.

Steps S1204b and S1205b are the same as steps S803b and S804b in FIG. 8B, and a description thereof will be omitted.

In step S1206b, the control unit 201 reads out, from a RAM 205, the data received from the controller 300 via the network I/F 202, and determines whether the readout data is a recording end command. That is, the control unit 201 determines whether a recording end command is received. Upon determining that the recording end command is received, the control unit 201 ends recording of the moving image data in the data storage unit 203, and advances the process to step S1207b. Upon determining that the recording end command is not received, the control unit 201 returns the process to step S1206b. That is, the control unit 201 repeats the processing of step S1206b until the recording end command is received.

In step S1207b, the control unit 201 transmits information (recording end information) indicating that recording is to be ended to the digital video camera 100 via the network I/F 202. Note that the recording end information is information serving as a trigger for causing the network recorder 200 to transmit metadata at the end of recording.

Steps S1208b and S1209b are the same as steps S806b and S807b in FIG. 8B, and a description thereof will be omitted.

By executing the above-described steps, the network recorder 200 can start and end recording of moving image data received from the digital video camera 100 and acquire metadata from the digital video camera 100 at each timing.

FIG. 12C is an operation flowchart showing the characteristic operation of the digital video camera 100 according to the second embodiment.

Steps S1200c and S1201c are the same as steps S800a and S801a in FIG. 8A, and a description thereof will be omitted.

In step S1202c, a control unit 101 of the digital video camera 100 determines whether recording start information transmitted from the network recorder 200 in step S1203b of FIG. 12B is received via a network I/F 105. Upon determining that the recording start information is received, the control unit 101 advances the process to step S1203c. Upon determining that the recording start information is not received, the control unit 101 returns the process to step S1202c. That is, the control unit 101 repeats the processing of step S1202c until the recording start information is received.

Steps S1203c and S1204c to S1206c are the same as steps S803a and S805a to S807a in FIG. 8A, and a description thereof will be omitted.

In step S1207c, the control unit 101 determines whether recording end information transmitted from the network recorder 200 in step S1207b of FIG. 12B is received via the network I/F 105. Upon determining that the recording end information is received, the control unit 101 advances the process to step S1208c. Upon determining that the recording end information is not received, the control unit 101 returns the process to step S1207c. That is, the control unit 101 repeats the processing of step S1207c until the recording end information is received.

Steps S1208c to S1210c are the same as steps S810a to S812a in FIG. 8A. Particularly, note that in step S1210c, the control unit 101 generates recording end time information metadata in accordance with reception of the recording end information and transmits it to the network recorder 200.

As described above, the user can obtain the same effect as in the first embodiment without operating the digital video camera 100 by operating the controller 300 and transmitting the start and end of recording of moving image data to the network recorder 200.

According to the present invention, it is possible to provide a technique of, when recording a moving image file from moving image data received from an external image capturing apparatus, recording a completed metafile associated with the moving image data together.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A recording apparatus including a communication unit and configured to record moving image data received from an image capturing apparatus via the communication unit, comprising:
at least one processor and/or circuit; and
at least one memory storing computer program, which causes the at least one processor and/or circuit to function as following units:
an image file recording unit configured to record a moving image file by starting recording of the moving image data from the image capturing apparatus in accordance with reception of a recording start command via the communication unit and ending the recording of the moving image data in accordance with reception of a recording end command via the communication unit; and
a metafile recording unit configured to start creation of a metafile associated with the moving image data based on information concerning the creation of the metafile, the information being received at time of the reception of the recording start command via the communication unit and complete the metafile using metadata received at time of the reception of the recording end command.

2. The recording apparatus according to claim 1, wherein the program further causes the at least one processor and/or circuit to function as following units:
a unit configured to receive the recording start command and the recording end command from an external control apparatus;
a unit configured to request, upon receiving the recording start command, information concerning the creation of the metafile at the start of the recording from the image capturing apparatus, and request, upon receiving the recording end command, metadata at the end of the recording from the image capturing apparatus.

3. A control method of a recording apparatus including communication unit and configured to record moving image data received from an image capturing apparatus via the communication unit, comprising:
recording a moving image file by starting recording of the moving image data from the image capturing apparatus in accordance with reception of a recording start command via the communication unit and ending the recording of the moving image data in accordance with reception of a recording end command via the communication unit; and
starting creation of a metafile associated with the moving image data based on information concerning the creation of the metafile, the information being received at time of the reception of the recording start command via the communication unit and completing the metafile using metadata received at time of the reception of the recording end command.

4. A computer-readable recording medium on which is recorded a program for causing a computer to execute the method according to claim 3.

5. A system comprising an image capturing apparatus connected to a network, and a recording apparatus, wherein
the image capturing apparatus comprises:
at least one processor and/or circuit; and
at least one memory storing computer program, which causes the at least one processor and/or circuit of the image capturing apparatus to function as following units:
a first transmission unit configured to transmit moving image data obtained by image capturing by image capturing unit to the recording apparatus;
a second transmission unit configured to transmit, upon receiving an instruction to start recording, a recording start command to the recording apparatus and transmit, upon receiving an instruction to end the recording, a recording end command to the recording apparatus; and
a third transmission unit configured to transmit, upon receiving the instruction to start the recording, information concerning creation of a metafile associated with the moving image data at time of the start of the recording to the recording apparatus, and transmit, upon receiving the instruction to end the recording, metadata at time of the end of the recording to the recording apparatus, and
the recording apparatus comprises:
at least one processor and/or circuit; and
at least one memory storing computer program, which causes the at least one processor and/or circuit of the recording apparatus to function as following units:
an image file recording unit configured to record a moving image file by starting the recording of the moving image data from the image capturing apparatus in accordance with reception of the recording start command and ending the recording of the moving image data in accordance with reception of the recording end command; and
a metafile recording unit configured to start creation of a metafile associated with the moving image data based on information concerning the creation of the metafile, the information being received at time of the reception of the recording start command and complete the metafile using the metadata received at time of the reception of the recording end command.

6. A system comprising an image capturing apparatus connected to a network, a recording apparatus, and a control apparatus configured to control the recording apparatus, wherein
the control apparatus comprises:
at least one processor and/or circuit; and
at least one memory storing computer program, which causes the at least one processor and/or circuit of the control apparatus to function as following units:
a unit configured to transmit a recording start command to the recording apparatus in accordance with an instruction to start recording from a user, and transmit a recording end command to the recording apparatus in accordance with an instruction to end the recording from the user,
the recording apparatus comprises:
at least one processor and/or circuit; and
at least one memory storing computer program, which causes the at least one processor and/or circuit of the recording apparatus to function as following units:
a reception unit configured to receive moving image data from the image capturing apparatus;
an image file recording unit configured to record a moving image file by starting recording of the moving image data in accordance with reception of the recording start command and ending the recording of the moving image data in accordance with reception of the recording end command; and
a metafile recording unit configured to request, upon receiving the recording start command, information concerning creation of a metafile at the start of the recording from the image capturing apparatus, start the creation of the metafile associated with the moving image data based on information obtained by the request, request, upon receiving the recording end command, metadata at the end of the recording from the image capturing apparatus, and complete the metafile using the metadata obtained by the request, and
the image capturing apparatus comprises:
at least one processor and/or circuit; and
at least one memory storing computer program, which causes the at least one processor and/or circuit of the image capturing apparatus to function as following units:
a first transmission unit configured to transmit the moving image data obtained by an image capturing unit to the recording apparatus; and
a second transmission unit configured to transmit information concerning creation of a metafile and a metadata in accordance with a requests from the recording apparatus.
